(19) United States
(12) Patent Application Publication
(10) Pub. No.: US 2026/0349084 A1
(43) Pub. Date: Nov. 5, 2026

(54) LIDAR AND VEHICLE

(71) Applicant: AUTOX TECH PTE. LTD., SINGAPORE (SG)

(72) Inventors: Xin Wang, Shenzhen (CN); Yanan Zhi, Shenzhen (CN); Jianxiong Xiao, Shenzhen (CN); Zhenkun Wang, Shenzhen (CN); Yizhou Shan, Shenzhen (CN); Puxi Hu, Shenzhen (CN); Xi Zou, Shenzhen (CN); Xuhui Tao, Shenzhen (CN)

(73) Assignee: AUTOX TECH PTE. LTD., SINGAPORE (SG)

(21) Appl. No.: 19/194,037

(22) Filed: Apr. 30, 2025

(51) Int. Cl. G01S 7/481; G01S 7/4865; G01S 17/32; G01S 17/88

(52) U.S. Cl. CPC G01S 7/4817; G01S 7/4813; G01S 7/4865; G01S 17/32; G01S 17/88

(57) ABSTRACT

The disclosure provides a LiDAR including: an upper housing with a window; a lower housing; a ToF transceiver module, and an FMCW transceiver assembly including an FMCW transceiver module, a first mirror, and a second mirror. Wherein the FMCW transceiver module and the first mirror are disposed in the lower housing; the ToF transceiver module and the second mirror are disposed in the upper housing, and rotatable about a rotation axis; a first laser beam emitted by the ToF transceiver module exits through the window, a first echo generated by the first laser beam reflecting off objects returns; a second laser beam emitted by the FMCW transceiver module reflected off the first mirror and the second mirror and then exits through the window, and a second echo generated by the second laser beam reflecting from objects is sequentially reflected off the second mirror and the first mirror and then returns.

### TECHNICAL FIELD

The disclosure relates to the field of LiDAR, and in particular to a LiDAR and a vehicle.

### BACKGROUND

Vehicle-mounted LiDARs typically achieve a 360° horizontal field of view and a certain vertical field of view through laser scanning. Current vehicle-mounted LiDARs can be classified, according to detection principles, into Time of Flight (ToF) LiDARs and Frequency Modulated Continuous Wave (FMCW) LiDARs. ToF LiDARs emit laser pulses outward and obtain distance information of a target object by detecting a time difference between an emitted signal and an echo signal. Using multi-line laser scanning technology, real-time 3D ranging can be achieved to complete 3D imaging, generating point clouds with high density, good quality, and high precision. FMCW LiDARs emit frequency-modulated continuous lasers outward and obtain velocity and distance information of a target object by processing interference between an echo laser and a local oscillator laser. Real-time velocity of a target object can be immediately obtained through a Doppler shift effect, with high velocity measurement precision and strong anti-interference ability.

However, ToF LiDARs can only achieve velocity measurement by repeatedly scanning the same target object and calculating a distance difference within a unit time, resulting in velocity measurement data with lag, susceptibility to interference, low precision, and poor velocity measurement effects. When FMCW LiDARs use multi-line laser scanning imaging, they require much more structural space and system resources than ToF LiDARs.

### SUMMARY

In view of the above, it is necessary to provide a LiDAR and a vehicle that can achieve high-quality, large field-of-view ranging and velocity measurement functions while avoiding excessive occupation of structural space and system resources by the LiDAR.

In a first aspect, the disclosure provides a LiDAR, including: an upper housing, with a window; a lower housing; a ToF transceiver module, and an FMCW transceiver assembly, including: an FMCW transceiver module, a first mirror, and a second mirror. wherein: the FMCW transceiver module and the first mirror are disposed in the lower housing; the ToF transceiver module and the second mirror are disposed in the upper housing, the ToF transceiver module and the second mirror are rotatable about a rotation axis; a first laser beam emitted by the ToF transceiver module exits through the window, and a first echo generated by the first laser beam reflecting off objects returns through the window to the ToF transceiver module; and a second laser beam emitted by the FMCW transceiver module reflected off the first mirror and the second mirror and then exits through the window, and a second echo generated by the second laser beam reflecting from objects is sequentially reflected off the second mirror and the first mirror and then returns to the FMCW transceiver module through the window.

In a second aspect, the disclosure further provides a vehicle, including a vehicle body; and a LiDAR comprising: an upper housing, with a window; a lower housing; a ToF transceiver module, and an FMCW transceiver assembly, comprising: an FMCW transceiver module, a first mirror, and a second mirror; wherein: the FMCW transceiver module and the first mirror are disposed in the lower housing; the ToF transceiver module and the second mirror are disposed in the upper housing, the ToF transceiver module and the second mirror are rotatable about a rotation axis; a first laser beam emitted by the ToF transceiver module exits through the window, and a first echo generated by the first laser beam reflecting off objects returns through the window to the ToF transceiver module; and a second laser beam emitted by the FMCW transceiver module reflected off the first mirror and the second mirror and then exits through the window, and a second echo generated by the second laser beam reflecting from objects is sequentially reflected off the second mirror and the first mirror and then returns to the FMCW transceiver module through the window.

In the LiDAR and the vehicle described above, the ToF transceiver module and the FMCW transceiver module are integrated in the same LiDAR, and the ToF transceiver module and the FMCW transceiver module are controlled to operate synchronously. By disposing the FMCW transceiver module in the lower housing and cooperating with the first mirror and the second mirror, the FMCW transceiver module can be disposed in a stationary lower housing, which can avoid excessive size and weight of the upper housing and reduce structural space and weight occupied by the upper housing.

By driving the ToF transceiver module and the second mirror to rotate about the rotation axis through the rotating member, overall dynamic balance of the LiDAR and driving force of the drive motor can be reduced, and the ToF transceiver module and the FMCW transceiver module can share a horizontal scanning mechanism, that is, the rotating member, to achieve synchronous scanning in a circumferential horizontal direction, thereby reducing size and weight after integration of the ToF transceiver module and the FMCW transceiver module and greatly reducing structural space required by the LiDAR as a whole.

### BRIEF DESCRIPTION OF THE DRAWINGS

To more clearly illustrate the technical solutions in the embodiments of the disclosure or in the prior art, the following provides a brief introduction to the drawings required for describing the embodiments or the prior art. It is apparent that the drawings described below are merely some embodiments of the disclosure. For those skilled in the art, other drawings can be obtained based on the structures shown in these drawings without exercising inventive effort.

FIG. 1 is a perspective view of a LiDAR in accordance with an embodiment.

FIG. 2 is an internal structural view of a LiDAR in accordance with an embodiment.

FIG. 3 is a cross-sectional view of a LiDAR provided by a first embodiment of the disclosure.

FIG. 4 is a cross-sectional view of a LiDAR provided by a second embodiment of the disclosure.

FIG. 5 is a system schematic diagram of a LiDAR in accordance with an embodiment.

FIG. 6 is a schematic diagram of a vehicle in accordance with an embodiment.

The realization of the objectives, functional features, and advantages of the disclosure will be further illustrated below in conjunction with the embodiments and with reference to the drawings.

### DETAILED DESCRIPTION OF THE EMBODIMENTS

In order to make the purpose, technical solution, and advantages of disclosure clearer and clearer, the following will provide further detailed explanations of disclosure in conjunction with the accompanying drawings and embodiments. It should be understood that the specific embodiments described here are only intended to explain the present application and are not intended to limit the present application. Based on the embodiments in disclosure, all other embodiments obtained by ordinary technical personnel in this field without creative labor fall within the scope of protection of disclosure.

The terms “first,” “second,” “third,” “fourth,” etc. (if present) in the specification, claims, and accompanying drawings of the present application are used to distinguish similar planning objects and are not necessarily used to describe a specific sequence or order. It should be understood that such terms, when used, may be interchangeable under appropriate circumstances. In other words, the described embodiments may be implemented in an order other than that illustrated or described herein. Furthermore, the terms “include” and “have” and any variations thereof may also encompass additional content. For example, a process, method, system, product, or device comprising a series of steps or units is not limited to only those steps or units clearly listed but may include other steps or units not clearly listed or inherent to those processes, methods, products, or device.

It is understood that the descriptions involving “first,” “second,” etc., in the present application are solely for descriptive purpos and should not be understood as indicating or implying their relative importance or implicitly specifying the number of indicated technical features. Therefore, features qualified by “first,” “second,” etc., may explicitly or implicitly include one or more of such features. In addition, the technical solutions among the various embodiments may be combined with each other, but this must be based on the ability of ordinary skilled artisans in the field to achieve such combinations. When the combination of technical solutions contradicts each other or cannot be implemented, such combinations should be deemed non-existent and not within the scope of protection claimed in the present application.

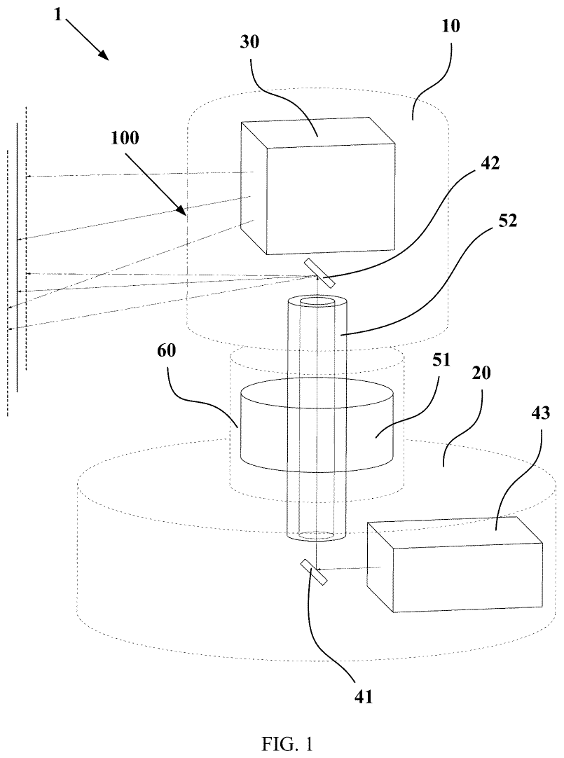

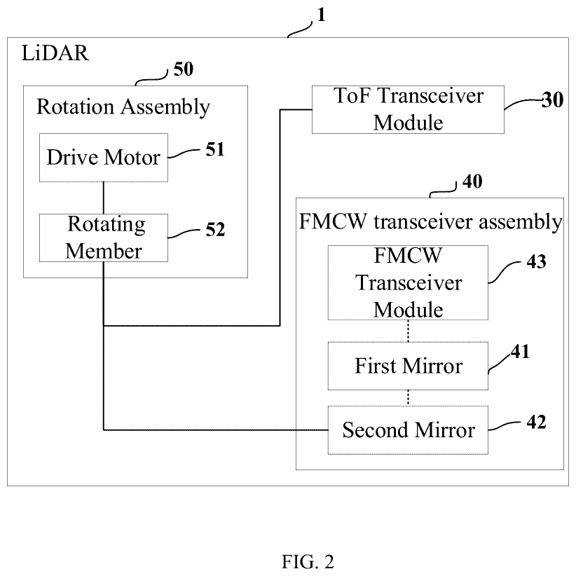

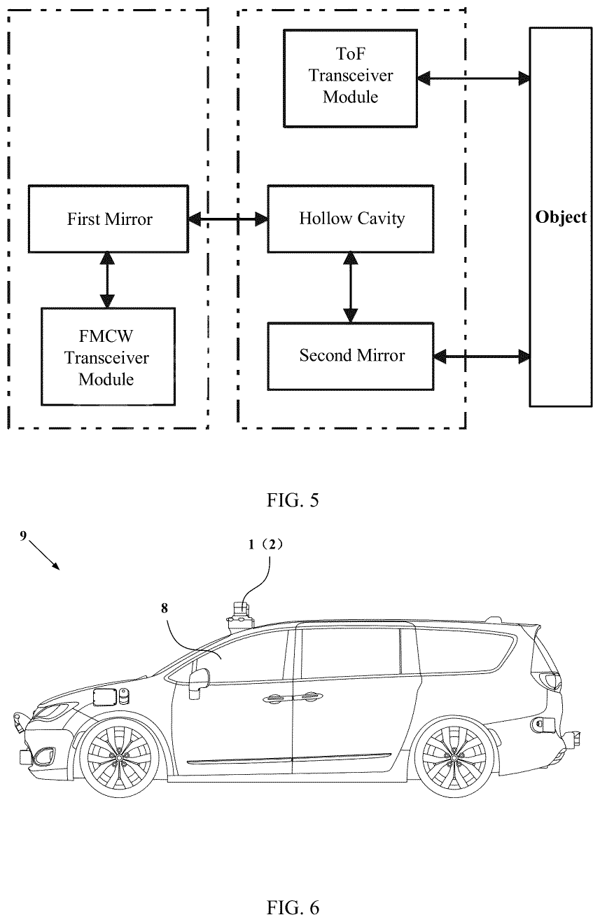

Referring FIGS. 1, 2, and 5. FIG. 1 is a perspective view of a LiDAR in accordance with an embodiment, FIG. 2 is an internal structural view of a LiDAR in accordance with an embodiment, and FIG. 5 is a system schematic diagram of a LiDAR in accordance with an embodiment. The LiDAR 1 includes an upper housing 10, a lower housing 20, a connection housing 60, a ToF transceiver module 30, and an FMCW transceiver assembly 40. The connection housing 60 is located between the upper housing 10 and the lower housing 20. In this embodiment, the connection housing 60 is connected to a side of the lower housing 20 facing the upper housing 10.

The upper housing 10 includes a shell 11 and a first installation cavity 101 disposed in the shell 11. The lower housing 20 includes a bottom shell 21 and a second installation cavity 201 disposed in the bottom shell 21. The connection housing 60 includes a housing body 61 and is provided with an accommodation cavity 600. It can be understood that the shell 11 encloses to form the first installation cavity 101, the bottom shell 21 encloses to form the second installation cavity 201, and the housing body 61 encloses to form the accommodation cavity 600. Specifically, the housing body 61 is connected to the bottom shell 21 and is integrally formed. The second installation cavity 201 and the accommodation cavity 600 are in communication.

In this embodiment, the shell 11 is overall in the shape of a hollow cylinder, the bottom shell 21 is overall in the shape of a hollow cube, and the housing body 61 is overall in the shape of a hollow cylinder. The bottom shell 21 is made of an aluminum alloy material, which can facilitate heat dissipation of an internal heat source.

The upper housing 10 is provided with a window 100, and the window 100 is opened on a side of the shell 11. The housing body 61 is provided with an opening 601 on a side facing the upper housing 10.

The FMCW transceiver assembly 40 includes an FMCW transceiver module 43, a first mirror 41, and a second mirror 42. In this embodiment, the FMCW transceiver module 43 and the first mirror 41 are disposed in the lower housing 20, and the second mirror 42 is disposed in the upper housing 10. Specifically, the FMCW transceiver module 43 and the first mirror 41 are fixedly disposed on the bottom shell 21. The second mirror 42 is a galvanometer mirror. Preferably, the second mirror 42 is a Micro-Electro-Mechanical System (MEMS) galvanometer mirror. Using a MEMS galvanometer mirror as the second mirror 42 can not only save space but also reduce scanning noise. In some feasible embodiments, the second mirror 42 can be a motor-driven galvanometer mirror (Galvo), or other types of galvanometer mirrors, which are not limited here.

In this embodiment, the second mirror 42 is rotatable about the rotation axis X. At the same time, the second mirror 42 is reciprocally swingable in a direction perpendicular to the rotation axis X, thereby achieving two-axis scanning of the FMCW transceiver module 43. That is to say, if a line along the direction perpendicular to the rotation axis X is set as a vertical line Y, the second mirror 42 rotates around the rotation axis X as a whole and also reciprocally swings along the vertical line Y. It can be understood that the rotation axis X and the vertical line Y are perpendicular to each other. The second mirror 42 reciprocally swings within a preset angular range. The preset angular range can be set according to actual needs of the LiDAR 1, and is not limited here.

A second laser emitted by the FMCW transceiver module 43 can exit sequentially through reflections by the first mirror 41 and the second mirror 42 and then through the window 100. A second echo formed by reflection of the second laser from an object can return sequentially through reflections by the second mirror 42 and the first mirror 41 and then through the window 100 to the FMCW transceiver module 43 and be received thereby. It can be understood that the first mirror 41 and the second mirror 42 are located on an optical path of the second laser emitted by the FMCW transceiver module 43 and the second echo received by the FMCW transceiver module 43. The first mirror 41 and the second mirror 42 can reflect the second laser and the second echo at a preset angle according to principles of geometrical optics. Specifically, the second laser emitted by the FMCW transceiver module 43 enters the first mirror 41, is reflected by the first mirror 41 to enter the second mirror 42, is reflected by the second mirror 42, and exits to the outside of the LiDAR 1 through the window 100. The second echo passes through the window 100 to enter the second mirror 42, is reflected by the second mirror 42 to enter the first mirror 41, is reflected by the first mirror 41, and enters the FMCW transceiver module 43 to be received thereby. The FMCW transceiver module 30 performs data processing based on interference between the second laser and the second echo to obtain distance and velocity information of the object, thereby generating corresponding point cloud data.

In this embodiment, since the second mirror 42 reciprocally swings along the vertical line Y, the second laser entering the second mirror 42 can form a plurality of beams under the swinging action of the second mirror 42. It can be understood that the plurality of beams are located in the same plane. The plurality of beams have certain angles therebetween.

In this embodiment, the second laser emitted by the FMCW transceiver module 43 propagates along a direction parallel to the vertical line Y; after being reflected by the first mirror 41, propagates along the rotation axis X; and after being reflected by the second mirror 42, exits from the window 100 in a direction roughly parallel to the vertical line Y. Correspondingly, the second echo enters the second mirror 42 from the window 100 in a direction roughly parallel to the vertical line Y, is reflected by the second mirror 42 to propagate along the rotation axis X, is reflected by the first mirror 41 to propagate along a direction parallel to the vertical line Y, and enters the FMCW transceiver module 43. It can be understood that the optical path is located in the second installation cavity 201, the accommodation cavity 600, and the first installation cavity 101.

In this embodiment, the FMCW transceiver module 43 can emit a single beam of second laser beam, or a plurality of beams of second laser beam. The number of beams of second laser beam emitted by the FMCW transceiver module 43 can be set according to actual needs of the LiDAR 1. Correspondingly, the second laser beam is frequency-modulated continuous laser light.

The ToF transceiver module 30 is disposed in the upper housing 10. In this embodiment, a first laser beam emitted by the ToF transceiver module 30 can exit through the window 100. A first echo formed by reflection of the first laser from an object can return through the window 100 to the ToF transceiver module 30 and be received thereby. The ToF transceiver module 30 performs data processing based on a time difference between the first laser and the first echo to obtain distance information of the object, thereby generating corresponding point cloud data. In this embodiment, the first laser beam emitted by the ToF transceiver module 30 exits from the window 100 in a direction roughly parallel to the vertical line Y. Correspondingly, the first echo enters the ToF transceiver module 30 from the window 100 in a direction roughly parallel to the vertical line Y. It can be understood that a transceiver end of the ToF transceiver module 30 is disposed opposite to the window 100.

In this embodiment, the ToF transceiver module 30 emits a plurality of beams of first laser beam, and the plurality of beams of first laser beam are spaced apart along a direction parallel to the rotation axis X. It can be understood that the plurality of beams of first laser beam are located in the same plane. The number of beams of first laser beam emitted by the ToF transceiver module 30 can be set according to actual needs of the LiDAR 1. Specifically, an angle between two outermost beams of first laser beam among the plurality of beams of first laser beam is a vertical field of view of the ToF transceiver module 30. The first laser beam is pulsed laser light.

In this embodiment, the ToF transceiver module 30 is rotatable about the rotation axis X. A direction in which the first laser beam exits from the window 100 is consistent with a direction in which the second laser beam exits from the window 100.

The LiDAR 1 further includes a rotation assembly 50, and the rotation assembly 50 includes a drive motor 51 and a rotating member 52. In this embodiment, the rotating member 52 is disposed on the drive motor 51, and the drive motor 51 is configured to drive the rotating member 52 to rotate. The rotation axis X is a central axis of the rotating member 52. It can be understood that the rotating member 52 rotates around the central axis, that is, the rotation axis X.

The drive motor 51 is accommodated in the accommodation cavity 600. Specifically, the drive motor 51 includes a rotor and a stator, the stator is disposed in the lower housing 20, the rotor is disposed in the accommodation cavity 600, and the rotor is connected to the rotating member 52. One end of the rotating member 52 is disposed on the lower housing 20, and the other end of the rotating member 52 passes through the accommodation cavity 600 and extends into the upper housing 10. In this embodiment, the other end of the rotating member 52 extends into the first installation cavity 101 through the opening 601. The stator is fixed to the bottom shell 21.

In this embodiment, the rotating member 52 is provided with a hollow cavity 520, and the hollow cavity 520 communicates the first installation cavity 101 and the second installation cavity 201. The first mirror 41 and the second mirror 42 are respectively disposed at two ends of the rotating member 52 and are located on the rotation axis X. After being reflected by the first mirror 41, the second laser beam passes through the hollow cavity 520 to enter the second mirror 42, and the second mirror 42 reflects the second laser beam to the window 100. It can be understood that the hollow cavity 520 provides space required by an optical path of the second laser emitted by the FMCW transceiver module 43 and the second echo received by the FMCW transceiver module 43. Preferably, the ToF transceiver module 30 is disposed on a side of the second mirror 42 away from the rotating member 52. Specifically, the rotating member 52 is a hollow mechanical shaft.

In this embodiment, the drive motor 51 drives the rotating member 52 to rotate at a constant speed. Preferably, the drive motor 51 drives the rotating member 52 to rotate at a constant speed of 360°. It can be understood that the drive motor 51 is a power device for horizontal scanning of the LiDAR 1 in a circumferential direction. Preferably, the drive motor 51 is a frameless motor. Using a frameless motor as the drive motor 51 can not only save space but also optimize a dynamic balance state of the upper housing 10.

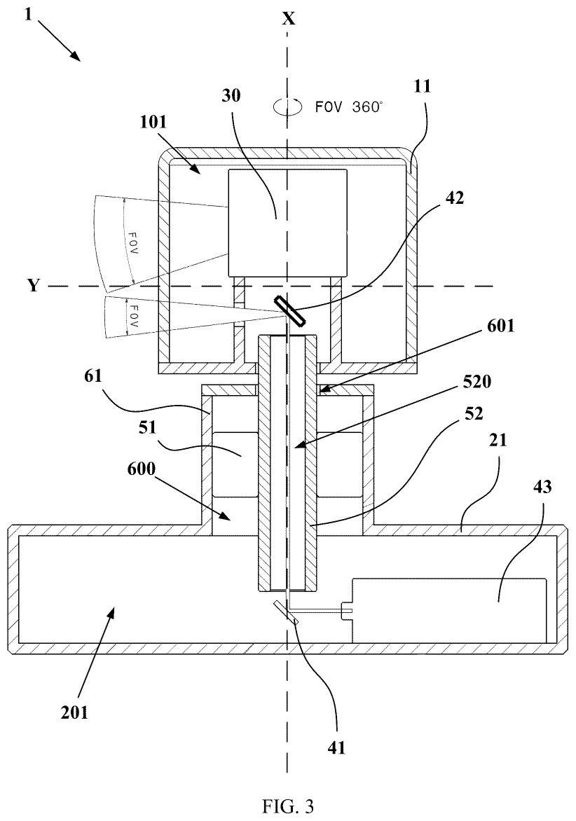

Please refer to FIG. 3, which is a cross-sectional view of a LiDAR provided by a first embodiment of the disclosure. In this embodiment, the upper housing 10 is fixed to the rotating member 52, and the upper housing 10, the ToF transceiver module 30 fixed to the upper housing 10, and the second mirror 42 rotate with the rotating member 52. Specifically, the upper housing 10 is fixed to the end of the rotating member 52 away from the lower housing 20. It can be understood that the shell 11 is connected to the rotating member 52, the ToF transceiver module 30 and the second mirror 42 are fixedly installed on the shell 11, and the upper housing 10 rotates with rotation of the rotating member 52.

In this embodiment, the FMCW transceiver module 43 emits a beam of second laser beam, and the beam of second laser beam forms a plurality of spaced-apart beams along a direction parallel to the rotation axis X via reflection by the second mirror 42. The plurality of beams are located in the same plane, and an angle between two outermost beams among the plurality of beams is a vertical field of view of the FMCW transceiver module 43.

In this embodiment, the ToF transceiver module 30 simultaneously emits 128 lines of first laser beam.

It can be understood that, since the rotating member 52 rotates around the rotation axis X, the rotating member 52 drives the upper housing 10 to rotate around the rotation axis X together, thereby achieving circumferential horizontal scanning of the ToF transceiver module 30 and the FMCW transceiver module 43. That is to say, the drive motor 51 drives the rotating member 52 to rotate 360°, so that the ToF transceiver module 30 and the FMCW transceiver module 43 form a 360° horizontal field of view.

In the above embodiments, the ToF transceiver module and the FMCW transceiver module are integrated in the same LiDAR, and the ToF transceiver module and the FMCW transceiver module are controlled to operate synchronously. By disposing the FMCW transceiver module in the lower housing and cooperating with the first mirror and the second mirror, the FMCW transceiver module can be disposed in a stationary lower housing, which can avoid excessive size and weight of the upper housing and reduce structural space and weight occupied by the upper housing.

By driving the ToF transceiver module and the second mirror to rotate around the rotation axis through the rotating member, overall dynamic balance of the LiDAR and driving force of the drive motor can be reduced, and the ToF transceiver module and the FMCW transceiver module can share a horizontal scanning mechanism, that is, the rotating member, to achieve synchronous scanning in a circumferential horizontal direction, thereby reducing size and weight after integration of the ToF transceiver module and the FMCW transceiver module and greatly reducing structural space required by the LiDAR as a whole. At the same time, the shell is in the shape of a cylinder, which can reduce wind resistance and rotational imbalance.

The ToF transceiver module adopts a multi-line scanning method, and the FMCW transceiver module adopts a two-axis scanning method. The two share a horizontal scanning mechanism, which reduces the number of beams of second laser beam, thereby effectively reducing occupied structural space and system resources.

The LiDAR integrates advantages of the ToF transceiver module and the FMCW transceiver module, can add velocity information to high-density ranging point clouds, and achieve real-time synchronous high-quality, large field-of-view ranging and velocity measurement functions, while avoiding excessive occupation of structural space and system resources by the LiDAR, and has broad application prospects in the field of vehicle-mounted LiDARs.

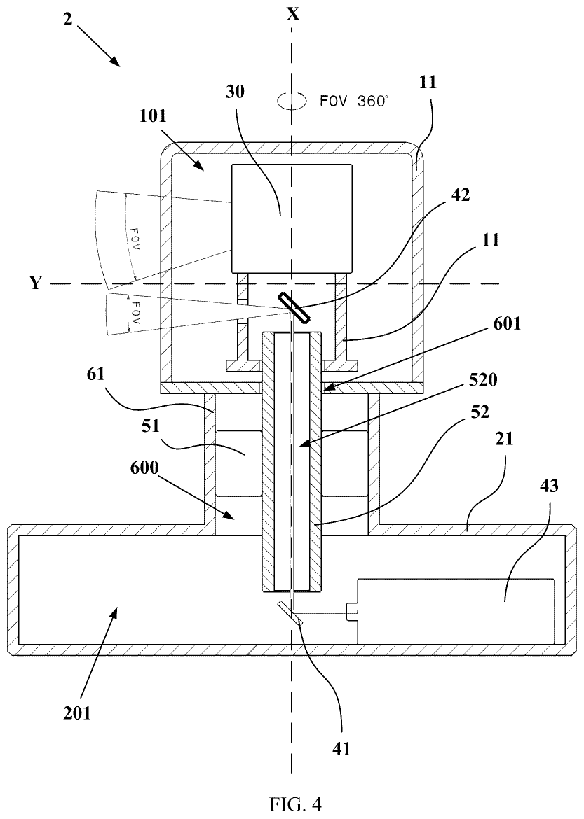

Please refer to FIG. 4, which is a cross-sectional view of a LiDAR provided by a second embodiment of the disclosure. A LiDAR 2 provided by the second embodiment differs from the LiDAR 1 provided by the first embodiment in that, in the LiDAR 2 provided by the second embodiment, the upper housing 10 is connected to the end of the connection housing 60 away from the lower housing 20. The upper housing 10 includes a rotating base 11, and the rotating base 11 is disposed on the rotating member 52. Specifically, the rotating base 11 is fixed to the end of the rotating member 52 away from the lower housing 20. In this embodiment, the rotating base 11 is mechanically connected to the rotating member 52. The ToF transceiver module 30 and the second mirror 42 are fixed to the rotating base 11. It can be understood that the rotating base 11 is connected to the rotating member 52, the ToF transceiver module 30 and the second mirror 42 are fixedly installed on the rotating base 11, and the ToF transceiver module 30 and the second mirror 42 rotate with the rotating base 11 around the rotating member 52. Correspondingly, the window 100 is an annular window.

In this embodiment, the FMCW transceiver module 43 emits a plurality of beams of second laser beam, and each beam of second laser beam forms a plurality of spaced-apart beams along a direction parallel to the rotation axis X via reflection by the second mirror 42. All beams of second laser beam formed are located in the same plane, and an angle between two outermost beams among all beams is a vertical field of view of the FMCW transceiver module 43. Specifically, the number of beams of second laser beam is less than or equal to 64. Preferably, the FMCW transceiver module 43 simultaneously emits 4 lines of second laser beam.

In this embodiment, the ToF transceiver module 30 simultaneously emits 256 lines of first laser beam.

Other structures of the LiDAR 2 provided by the second embodiment are basically the same as those of the LiDAR 1 provided by the first embodiment, and will not be repeated here.

Please refer to FIG. 5, which is a schematic diagram of a vehicle in accordance with an embodiment. The vehicle 9 includes a vehicle body 8 and the LiDAR 1 or the LiDAR 2. Specific structures of the LiDAR 1 and the LiDAR 2 are referred to in the above embodiments. In this embodiment, the LiDAR 1 or the LiDAR 2 is disposed on the vehicle body 8. A position where the LiDAR 1 or the LiDAR 2 is installed on the vehicle body 8 can be set according to actual application needs, and is not limited here.

Since the vehicle 9 adopts all technical solutions of the above embodiments, the vehicle 9 at least has all beneficial effects brought by the technical solutions of the above embodiments, and will not be repeated here.

It is apparent to those skilled in the art that various modifications and variations can be made to the disclosure without departing from the spirit and scope thereof. Therefore, if these modifications and variations of the disclosure fall within the scope of the claims of the disclosure and their equivalent technologies, the disclosure also intends to include these modifications and variations.

The above-listed are merely preferred embodiments of the disclosure, and of course, cannot be used to limit the scope of the claims of the disclosure. Therefore, equivalent changes made according to the claims of the disclosure still fall within the scope covered by the disclosure.

1. A LiDAR, comprising:
an upper housing, with a window;
a lower housing;
a ToF transceiver module, and
an FMCW transceiver assembly, comprising:
an FMCW transceiver module,
a first mirror, and
a second mirror;
wherein:
the FMCW transceiver module and the first mirror are disposed in the lower housing;
the ToF transceiver module and the second mirror are disposed in the upper housing, the ToF transceiver module and the second mirror are rotatable about a rotation axis;
a first laser beam emitted by the ToF transceiver module exits through the window, and a first echo generated by the first laser beam reflecting off objects returns through the window to the ToF transceiver module; and
a second laser beam emitted by the FMCW transceiver module reflected off the first mirror and the second mirror and then exits through the window, and a second echo generated by the second laser beam reflecting from objects is sequentially reflected off the second mirror and the first mirror and then returns to the FMCW transceiver module through the window.

2. The LiDAR according to claim 1, further comprising:
a rotation assembly, including:
a drive motor, and
a rotating member, disposed on the drive motor, and driven to rotate bydrive motor;
wherein:
the rotation axis is a central axis of the rotating member;
the upper housing is fixed to the rotating member, and
the upper housing the ToF transceiver module and the second mirror rotate together with the rotating member.

3. The LiDAR according to claim 2, wherein the second mirror is a galvanometer mirror oscillating about an axis perpendicular to the rotation axis; the FMCW transceiver module emits the second laser beam, when reflected off the second mirror, form a plurality of discrete beam spots spaced along a direction parallel to the rotation axis.

4. The LiDAR according to claim 2, further comprising a connection housing connected to a side of the lower housing facing the upper housing, and having an accommodation cavity receiving the drive motor, one end of the rotating member being disposed on the lower housing, the other end of the rotating member passing through the accommodation cavity and extending into the upper housing and fixed on the upper housing; wherein the first mirror and the second mirror are respectively positioned at opposite ends of the rotating member all the rotation axis, and the ToF transceiver module is disposed adjacent to the second mirror on a side opposite to the rotating member.

5. The LiDAR according to claim 2, wherein the upper housing comprises a rotating base disposed on the rotating member, the ToF transceiver module and the second mirror being fixed to the rotating base, and the ToF transceiver module and the second mirror rotating with the rotating base about the rotating member.

6. The LiDAR according to claim 5, wherein the second mirror is a galvanometer mirror oscillating about an axis perpendicular to the rotation axis; the FMCW transceiver module emits the second laser beam, when reflected off the second mirror, form a plurality of discrete beam spots spaced along a direction parallel to the rotation axis.

7. The LiDAR according to claim 5, further comprising a connection housing connected between the lower housing and the upper housing and having an accommodation cavity to receive the drive motor, one end of the rotating member being disposed on the lower housing, the other end of the rotating member passing through the accommodation cavity and extending into the upper housing, the rotating base being fixed to the end of the rotating member away from the lower housing; wherein the first mirror and the second mirror are respectively disposed at two ends of the rotating member along the rotation axis, and the ToF transceiver module is disposed adjacent to the second mirror on a side opposite to the rotating member.

8. The LiDAR according to claim 7, wherein the rotating member defines a hollow cavity, the second laser beam is reflected by the first mirror into the hollow cavity and directed through the hollow cavity to the second mirror, and reflected by the second mirror toward the window, and the first laser beam and the second laser beam exit the window in substantially parallel directions.

9. The LiDAR according to claim 1, wherein the ToF transceiver module emits a plurality of first laser beams spaced apart along a direction parallel to the rotation axis.

10. A vehicle, comprising
a vehicle body; and
a LiDAR comprising:
an upper housing, with a window;
a lower housing;
a ToF transceiver module, and
an FMCW transceiver assembly, comprising:
an FMCW transceiver module,
a first mirror, and
a second mirror;
wherein:
the FMCW transceiver module and the first mirror are disposed in the lower housing;
the ToF transceiver module and the second mirror are disposed in the upper housing, the ToF transceiver module and the second mirror are rotatable about a rotation axis;
a first laser beam emitted by the ToF transceiver module exits through the window, and a first echo generated by the first laser beam reflecting off objects returns through the window to the ToF transceiver module; and
a second laser beam emitted by the FMCW transceiver module reflected off the first mirror and the second mirror and then exits through the window, and a second echo generated by the second laser beam reflecting from objects is sequentially reflected off the second mirror and the first mirror and then returns to the FMCW transceiver module through the window.

11. The vehicle according to claim 10, wherein the LiDAR further comprises:
a rotation assembly, including:
a drive motor, and
a rotating member, disposed on the drive motor, and driven to rotate bydrive motor;
wherein:
the rotation axis is a central axis of the rotating member;
the upper housing is fixed to the rotating member, and
the upper housing the ToF transceiver module and the second mirror rotate together with the rotating member.

12. The vehicle according to claim 11, wherein the second mirror is a galvanometer mirror oscillating about an axis perpendicular to the rotation axis; the FMCW transceiver module emits the second laser beam, when reflected off the second mirror, form a plurality of discrete beam spots spaced along a direction parallel to the rotation axis.

13. The vehicle according to claim 11, wherein the LiDAR further comprises a connection housing connected to a side of the lower housing facing the upper housing, and having an accommodation cavity receiving the drive motor, one end of the rotating member being disposed on the lower housing, the other end of the rotating member passing through the accommodation cavity and extending into the upper housing and fixed on the upper housing; wherein the first mirror and the second mirror are respectively positioned at opposite ends of the rotating member all the rotation axis, and the ToF transceiver module is disposed adjacent to the second mirror on a side opposite to the rotating member.

14. The vehicle according to claim 11, wherein the upper housing comprises a rotating base disposed on the rotating member, the ToF transceiver module and the second mirror being fixed to the rotating base, and the ToF transceiver module and the second mirror rotating with the rotating base about the rotating member.

15. The vehicle according to claim 14, wherein the second mirror is a galvanometer mirror oscillating about an axis perpendicular to the rotation axis; the FMCW transceiver module emits the second laser beam, when reflected off the second mirror, form a plurality of discrete beam spots spaced along a direction parallel to the rotation axis.

16. The vehicle according to claim 14, wherein the LiDAR further comprises a connection housing connected between the lower housing and the upper housing and having an accommodation cavity to receive the drive motor, one end of the rotating member being disposed on the lower housing, the other end of the rotating member passing through the accommodation cavity and extending into the upper housing, the rotating base being fixed to the end of the rotating member away from the lower housing; wherein the first mirror and the second mirror are respectively disposed at two ends of the rotating member along the rotation axis, and the ToF transceiver module is disposed adjacent to the second mirror on a side opposite to the rotating member.

17. The vehicle according to claim 16, wherein the rotating member defines a hollow cavity, the second laser beam is reflected by the first mirror into the hollow cavity and directed through the hollow cavity to the second mirror, and reflected by the second mirror toward the window, and the first laser beam and the second laser beam exit the window in substantially parallel directions.

18. The vehicle according to claim 10, wherein the ToF transceiver module emits a plurality of first laser beams spaced apart along a direction parallel to the rotation axis.
